(19) United States
(12) Patent Application Publication
(10) Pub. No.: US 2004/0034809 A1
(43) Pub. Date: Feb. 19, 2004

(54) Memory management configuration and method for making a main memory

(76) Inventors: Martin Versen, Munchen (DE); Martin Tilch, Munchen (DE); Srednesh Nair, Munchen (DE); Manfred Moser, Dachau (DE)

Correspondence Address: LERNER AND GREENBERG, P.A., POST OFFICE BOX 2480, HOLLYWOOD, FL, 33022-2480, US

(21) Appl. No.: 10/640,232

(22) Filed: Aug. 13, 2003

(30) Foreign Application Priority Data
Aug. 13, 2002 (DE) 102 37 121.0

(51) Int. Cl. H04L 1/22

(52) U.S. Cl. 714/6

(57) ABSTRACT

A memory management configuration and a method for the memory management of a main memory are provided. An access to a memory area of the main memory that is known to be defective is diverted into an additional memory.

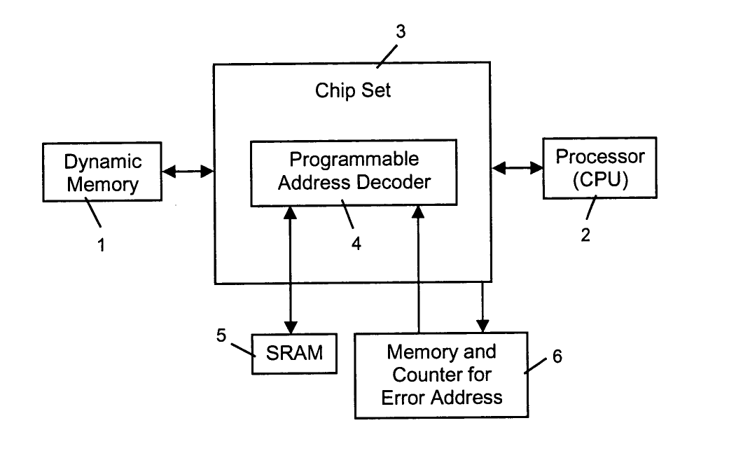

### BACKGROUND OF THE INVENTION

### FIELD OF THE INVENTION

The invention lies in the memory technology field and relates, more specifically, to a memory management configuration and a method for the memory management of a main memory.

Customary computer systems are constructed in such a way that a processor, also referred to as a central processing unit or CPU, is assigned a main memory. The main memory may comprise a plurality of memory components, the latter in turn being composed of a multiplicity of DRAM memory cells. In order that the main memory can be composed of standard components and can be combined with a correspondingly suitable CPU for the respective area of application, the communication between the processor and the main memory takes place via a so-called chip set. In the latter, by way of example, an address addressed by the processor is converted into the call of the actual physical memory area hiding behind the address in the main memory. Single bit errors regularly occur during the operation of the DRAM memory elements, which errors in turn lead to losses of information. Such losses of information are to be avoided, of course, at least in specific applications.

There exist a variety of reasons for these so-called single bit errors. Firstly, DRAM memory components are increasingly sensitive to alpha radiation on account of the small feature sizes and the minimized operating voltage. Consequently, the single bit errors occurring as a result of this can never be entirely ruled out.

For this reason, many manufacturers employ a so-called ECC method (ECC, error check and correction) at the system level. Through specific algorithms, in some cases, the ECC method enables an error correction which always causes an error message in the chip set. Other single bit errors arise for example as a result of operation or arose during the production of the DRAM element and were overlooked on account of less than 100% test coverage during the production test.

In comparison with the single bit errors generated by alpha radiation, single bit errors which have arisen as a result of operation or as a result of production occur repeatedly. These single bit errors are also documented, and corrected, by the “ECC method.” If the error list is so long as to disturb the user, the corresponding module or the corresponding modules is or are exchanged. Such exchange is unpleasant since no work can be done at the data processing system in the meantime. This is highly disturbing particularly when the corresponding data processing system is not routinely switched off, but rather in principle remains in operation.

### SUMMARY OF THE INVENTION

It is accordingly an object of the invention to provide a memory management configuration and a method of managing a main memory, which overcomes the above-mentioned disadvantages of the heretofore-known devices and methods of this general type and wherein it is possible, even with the occurrence of a multiplicity of single bit errors, to avoid the exchange of DRAM components of the main memory to a greater extent.

With the foregoing and other objects in view there is provided, in accordance with the invention, a memory management configuration, comprising:

a processor;

a dynamic main memory;

a communication device connected between the main memory and the processor for enabling the processor to access the main memory; and

an additional memory connected to the communication device such that address access to memory areas of the main memory known to be defective can be diverted to the additional memory.

The objects of the invention are achieved with this configuration. By virtue of the fact that, in the event of an access to a main memory area that is known to be defective, a communication device between the processor and the main memory diverts the access to an additional memory, defective memory areas of the main memory are replaced by the additional memory. This obviates an exchange of a memory component in the main memory as long as there is a sufficient amount of memory space provided in the additional memory.

In accordance with an added feature of the invention, there is further provided an auxiliary memory for storing the addresses of memory areas in the main memory that are known to be defective.

In accordance with a preferred implementation of the invention, the main memory is formed with DRAM memory components, the additional memory is a volatile memory, and/or the additional memory comprises a plurality of SRAM memory components.

The auxiliary memory may be either a nonvolatile memory or a volatile memory.

With the above and other objects in view there is also provided, in accordance with the invention, an improved method for the memory management of a main memory. The improved method includes the following steps:

ascertaining defective memory areas at a predetermined point in time; and

on occasion of an access to a defective memory area, diverting the access to a memory area in an additional memory.

The novel method is particularly suitable for the above-summarized configuration.

In accordance with another feature of the invention, the configuration is provided with an auxiliary memory connected to the communication device, and the addresses of defective memory areas are stored in the auxiliary memory.

In accordance with a concomitant feature of the invention, on occasion of an access to the main memory, the address to be accessed is compared with the addresses stored in the auxiliary memory, to thereby detect an access to a memory area known to be defective.

By virtue of the fact that an auxiliary memory is additionally provided, wherein are stored the addresses of the memory cells known to be defective, it is easily possible for the communication device, in the event of an access by the processor to the main memory, to ascertain by comparison with the addresses stored in the auxiliary memory whether an access to a defective memory area is to be effected in order then to divert the latter. For cost reasons, the main memory is a DRAM memory component, which can be produced cost-effectively with very much memory space, whereas for the additional memory an SRAM memory component is advantageously chosen, which has a significantly higher reliability than DRAM memory components but cannot be produced as cost-effectively on account of the smaller memory space per chip area.

If the information stored in the auxiliary memory is intended to remain available after the apparatus has been switched off and switched on again, the auxiliary memory must be designed as a nonvolatile memory, such as, for example, a so-called “flash” memory or, for example, as a hard disk. If the auxiliary memory is designed as a volatile memory, then the defective memory areas have to be determined anew after the apparatus has been switched on again. This is an advantageous solution particularly when the arrangement is accommodated in a data processing apparatus which in principle remains in operation and, by way of example, is switched off only for a necessary exchange of components, such as, for example, DRAM memory components of the main memory.

Other features which are considered as characteristic for the invention are set forth in the appended claims.

Although the invention is illustrated and described herein as embodied in a memory management configuration and a method for the memory management of a main memory, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing is a diagram of a processor, often referred to as a CPU, connected to a main memory via a communication device.

### DESCRIPTION OF THE PREFERRED EMBODIMENTS

Referring now to the FIGURE of the drawing in detail, there is shown a processor 2, often also referred to as a CPU (central processing unit), connected to a main memory 1 via a communication device 3. The main memory 1 is formed from so-called DRAM memory components (DRAM, dynamic random access memory). The communication device 3 is formed from components which, in their totality, are usually referred to as a chip set. The communication device comprises a programmable address decoder 4, which converts an access by the processor 2 to a specific address of an address range that is actually present in the main memory 1.

An auxiliary memory 6 is connected to the communication device 3. Test routines that proceed regularly in the processor determine defective memory areas in the main memory 1 and are communicated to the communication device 3. The latter in turn stores the information about the corresponding addresses in the auxiliary memory 6. A regular call of an address in the main memory 1 by the processor 2 then takes place, the communication device fetches the information about the defective memory areas in the main memory 1 from the auxiliary memory 6 and diverts the access to the main memory 1 in such a way that, in the event of an access to a defective memory area, the programmable address decoder 4 is reprogrammed in such a way that the additional memory 5 is accessed rather than the defective memory area in the main memory 1.

This takes place both when the processor 2 reads from the main memory 1 and when it writes to the main memory 1. Since it would not be expedient for the additional memory 5 to have defects, a so-called SRAM component (SRAM, static random access memory) is chosen for the additional memory 5. These components have significantly less frequent single bit errors, but are also significantly more expensive since with them it is not possible to obtain the same high storage density per chip area used as is possible with the so-called DRAM components. Of course, the disturbance of single bit errors in the additional memory 5, should the latter actually occur in the first place, can be avoided through corresponding reprogramming of the programmable address decoder or through a corresponding entry in the auxiliary memory 6.

We claim:

1. A memory management configuration, comprising:
a processor;
a dynamic main memory;
a communication device connected between said main memory and said processor for enabling said processor to access said main memory; and
an additional memory connected to said communication device such that address access to memory areas of said main memory known to be defective can be diverted to said additional memory.

2. The configuration according to claim 1, which comprises an auxiliary memory connected to said communication device, said auxiliary memory storing addresses of memory areas of said main memory known to be defective.

3. The configuration according to claim 1, wherein said main memory comprises a plurality of DRAM memory components.

4. The configuration according to claim 1, wherein said additional memory is a volatile memory.

5. The configuration according to claim 4, wherein said additional memory comprises a plurality of SRAM memory components.

6. The configuration according to claim 2, wherein said auxiliary memory is a nonvolatile memory.

7. The configuration according to claim 2, wherein said auxiliary memory is a volatile memory.

8. In a method for the memory management of a main memory, the improvement which comprises:
ascertaining defective memory areas at a predetermined point in time; and
on occasion of an access to a defective memory area, diverting the access to a memory area in an additional memory.

9. The method according to claim 8, which comprises storing addresses of defective memory areas in an auxiliary memory.

10. The method according to claim 9, which comprises, on occasion of an access to the main memory, comparing the address to be accessed with the addresses stored in the auxiliary memory, to thereby detect an access to a memory area known to be defective.

11. A memory management method, which comprises: providing a configuration according to claim 1;
ascertaining defective memory areas in the main memory; and
on occasion of an access to a defective memory area in the main memory, diverting the access to a memory area in the additional memory.

12. The method according to claim 13, which comprises providing the configuration with an auxiliary memory connected to the communication device, and storing addresses of defective memory areas in the auxiliary memory.

13. The method according to claim 12, which comprises, on occasion of an access to the main memory, comparing the address to be accessed with the addresses stored in the auxiliary memory, to thereby detect an access to a memory area known to be defective.
